(19) United States
(12) Patent Application Publication
(10) Pub. No.: US 2023/0085139 A1
(43) Pub. Date: Mar. 16, 2023

(54) STRUCTURE OF DIFFERENTIAL TELESCOPIC ELLIPTICAL ARCS, CONSISTING OF MULTIPLE TWO-AXIS SUN-TRACKERS MECHANISMS

(71) Applicant: Peter Graner, Kfar Saba (IL)

(72) Inventor: Peter Graner, Kfar Saba (IL)

(21) Appl. No.: 17/798,957

(22) PCT Filed: Feb. 10, 2021
(86) PCT No.: PCT/IL2021/050160

§ 371 Date: Aug. 11, 2022

(30) Foreign Application Priority Data
Feb. 11, 2020 (IL) 272608

(51) Int. Cl. H02S 20/32; G06F 1/00; F24S 30/45

(52) U.S. Cl. CPC H02S 20/32; G06F 1/00; F24S 30/45

(57) ABSTRACT

It is t an object of the present invention to provide an improved smart sun tracking systems that are expanding in three different directions, configured with multiple two-axis sun-trackers integrated with various single or step-aside double layers of hybrid Dual faces PV thermal panels to only two swiveling couplers in different directions with two driven main cables in closed loops (North-South and East-West), define the 4-dimension structure, and strong enough to withstand wind loading and the like without the structural reinforcement here to for required. Another object of the present invention is to provide an improved sun tracking systems for solar energy radiation receivers, which can be built from a minimum number of inexpensive parts and minimum maintenance. Additional objects, advantages and novel features of the invention will be set forth in part in the description which follows, and in part will become apparent to those skilled in the prior art upon examination of the following or may be learned by application of the invention. The objects and advantages of the invention may be realized and attained by means of the instrumentalities and combinations particularly pointed out in the appended claims two electric motorized pulley attachments, connecting the closed loops cables to each 3-solar energy radiation receivers' to sub-assembly support beam, mounted on mast pillars at different lengths allow to provide a wide range of adjustments, i.e. wherein the 3-units of solar energy radiation receivers, reversing directions according to the seasons and when is needed. A clockwise and counter-clockwise electric motorized pulley, connected to dual direction main cables design is biased to maintain differential positions. When underneath the 3-units of solar energy radiation receivers connected central support beam which connected to swivel coupler and a pair of differential locations hooks. The smart sun-trackers system comprising multiple two-axis sun-trackers connected with cables in closed loops, provides required forms of multiple at least one or more 3-units of solar energy radiation receiver's mounted above sub-support beam assembly, when the cables are moving back and forth. The mechanism includes an electric motorized pulley shaft rotating in a different direction parallel to the cable portion to which the mechanism is attached. Because the cables connected in 2 different locations attached to the central support beam, allow the central main mast pillars swivel with the same cables length displacement following the movements which occur between all differential step-aside main mast pillars, respectively to North-South positions, providing the necessary solar energy radiation receiver adjustment desired. The same principles works with the East-West differential movements' when main mast pillars step-aside relative to solar energy radiation receivers sub-assembly modules of multiple units of 3-solar energy radiation receivers as described above. The solar energy radiation receivers could be of the; solar flat-plate type, or other configurations, such as various single or step-aside double layers of hybrid Dual faces PV thermal panels.

### FIELD OF THE INVENTION

The present invention relates to the field of renewable energy, for improving an existing conventional two-Axis Sun-Tracker and the shaded free space between multiple two-axis sun trackers, with a unique mechanisms systems of smart structure of differential telescopic elliptical arcs, consisting of multiple two-axis sun-trackers mechanisms, allows installing of additional quantity of single or double layers of step-aside layers of hybrid dual faced PV thermal panels or any solar energy radiation receivers, in the free space between the shaded rows.

The result of introducing the smart structure of differential telescopic elliptical arcs, consisting of multiple two-axis sun-trackers mechanisms, Called “smart system”, is the ability to increase the yearly amount of energy production efficiency, by having an additional of at least 45% hours of direct and efficient sun radiation exposure, without loss of energy at the hottest temperature periods of the day, due to additional cooling systems capabilities integrated with the hybrid dual faced PV thermal panels, increasing the energy production efficiency by at least 18%. These results generates a gross additional of electricity and hot water, which gain of at least 200% and more energy on the same footprint, when compared to current production with existing technology.

### BACKGROUND OF THE INVENTION

This invention pertains to movable various solar energy radiation receivers, and in particular, to Sun Tracking systems for such solar energy radiation receivers. Although movable type solar energy radiation receivers are generally more costly than static (Fix) installation of solar energy radiation receivers, they provide increased solar energy collection throughout the additional energy efficient of daylight hours. One major drawback is the high cost factor of sun-tracker mechanisms for solar energy radiation receivers and maintenance, since the PV panel's price dropped by about 80% in the last decade, this low price attributed to the mechanical Sun-tracking mechanism to be without financial efficiency relative to the cost of Fixed PV panel's installation. A substantial commercial advantage could, therefore, be obtained when additional single or double layers step aside of Hybrid Bifacial PV Thermal panels or any solar energy radiation receivers integrated with mirrors, can be installed in on all sub-assembly modules 102 and within the free space between rows, such as, for example, those disclosed in patent IL 255843, this would allow for the ability to constantly fulfil the demands for high energy in urban, industrial and commercial areas, and have those requirements met with the addition of a unique differential telescopic elliptical arcs of 2-axis 4-Dimension multiple Sun-Tracker mechanisms, this mechanism when integrated with various solar energy radiation receivers and mirrors. Along with its low profile structure shape, enables installation above buildings roofs. Currently, several other competitor systems such as swivel mast pillar Two-axis Sun-tracker and some linear trackers facilities have integration with solar PV/collectors. These systems generally fail to provide sufficient amounts of energy and power. A high efficiency on a small footprint is necessary for crowded commercial, and industrial spaces and for other urban electric uses, such as for example those which are disclosed in U.S. Pat. No. 4,425,904A, WO1999055197A1, US20030070708A1, CN101551164B, DE212009000065U1 has another major drawback as they lack the ability to generate high electric power and hot water within a relatively small area, this makes them unable to be used as a core power source for the implementation of an smart sun-trackers system (multiple two-axis sun-trackers mechanisms consist differential telescopically in elliptical arcs rows which consist of multiple cables integrated within). Moreover, very few novel smart sun tracking systems are capable of being installed above buildings, on the ground, on ships, and other various locations.

### SUMMARY OF THE INVENTION

It is therefore an object of the present invention to provide an improved smart sun tracking systems that are expanding in three different directions, configured with multiple two-axis sun-trackers integrated with various single or step-aside double layers of hybrid Dual faces PV thermal panels to only two swiveling couplers in different directions with two driven main cables in closed loops (North-South and East-West), define the 4-dimension structure, and strong enough to withstand wind loading and the like without the structural reinforcement heretofore required.

Another object of the present invention is to provide an improved sun tracking systems for solar energy radiation receivers, which can be built from a minimum number of inexpensive parts and minimum maintenance.

Additional objects, advantages and novel features of the invention will be set forth in part in the description which follows, and in part will become apparent to those skilled in the prior art upon examination of the following or may be learned by application of the invention. The objects and advantages of the invention may be realized and attained by means of the instrumentalities and combinations particularly pointed out in the appended claims.

two electric motorized pulley attachments, connecting the closed loops cables to each 3-solar energy radiation receivers' to sub-assembly support beam, mounted on mast pillars at different lengths allow to provide a wide range of adjustments, i.e. wherein the 3-units of solar energy radiation receivers, reversing directions according to the seasons and when is needed. A clockwise and counter-clockwise electric motorized pulley, connected to dual direction main cables design is biased to maintain differential positions. When underneath the 3-units of solar energy radiation receivers connected central support beam which connected to swivel coupler and a pair of differential locations hooks.

The smart sun-trackers system comprising multiple two-axis sun-trackers connected with cables in closed loops, provides required forms of multiple at least one or more 3-units of solar energy radiation receiver's mounted above sub-support beam assembly, when the cables are moving back and forth. The mechanism includes an electric motorized pulley shaft rotating in a different direction parallel to the cable portion to which the mechanism is attached. Because the cables connected in 2 different locations attached to the central support beam, allow the central main mast pillars swivel with the same cables length displacement following the movements which occur between all differential step-aside main mast pillars, respectively to North-South positions, providing the necessary solar energy radiation receiver adjustment desired. The same principles works with the East-West differential movements' when main mast pillars step-aside relative to solar energy radiation receivers sub-assembly modules 102 multiple units of 3-solar energy radiation receivers as described above. The solar energy radiation receivers could be of the; solar flat-plate type, or other configurations, such as various single or step-aside double layers of hybrid Dual faces PV thermal panels.

### DESCRIPTION OF THE DRAWINGS

FIG. 1 An Isometric view of typical smart Multiple two-axis sun trackers mechanisms of columns and rows in winter mode, which consist structures of multiple cables, called “systems” which illustrate one of the examples of multiple different columns and rows of solar tracking systems, comprising solar energy radiation receivers according to the invention.

FIG. 2 Side view of a single-axis sun-trackers mechanisms showing the configuration of several telescopic expanding elliptical arcs rows which consist of multiple cables within a multiple movements, show different season's relative for differential positions of units at least one or more-solar energy radiation receivers for example, 3 units are shown) relative to the sun North-South (seasons).

FIG. 3A various combination side view that presents a collection of various seasons as in Winter, Summer and Summer morning and Sumer afternoon.

FIG. 4 Front view A of daily sun path East-West according to the invention.

FIG. 5 Isometric view of first position in winter (the sun in its lowest position), showing the shadowing in the free space (free distance) between the rows, this means that a number of solar energy receivers are not exposed to solar radiation for a period of 1-4 months, after which, coming out from the shaded mode.

FIG. 6 is an isometric view of several closed loops cables, mounted according to the changes between the seasons (North-South) and daily sun path (East-West).

FIG. 7 Isometric view of single general structure for 3-units of solar energy radiation receivers and front view-A.

FIG. 8 Isometric view of single basis support structure with several cables integrated support rollers.

### DETAILED DESCRIPTION OF THE PREFERRED EMBODIMENT

A unique smart Telescopic differential expanding elliptical arc rows movements, which consist of multiple closed loops cables in differential hook distances for example, can be in ranges from 5-50-cm, when integrated within a multiple two-axis sun-trackers mechanisms, enable for additional quantities of single or step-aside double layers of hybrid dual faced PV thermal panels, or any solar energy radiation receivers, to be integrated in the shaded free space between rows. These systems are enabling for a plurality of step-aside mainmast pillars operating in differential lengths and differential distances between the cables hooks, which when connected to the main support beams, and pivotally mounted, when the 3-units solar energy radiant receivers of each single two-axis sun-trackers mechanism 103, are spaced-apart in differential configuration, and arranged in variant positions. Define by at least one or more units (for example 3-units; of solar energy radiation receivers mounted on two supports rails, connected to sub-support beam with evacuated sections configure in the shape of an H, those mounted on main support beam, which connected to differential lengths of main mast pillars rotating in direction of North-South by electric motorized pulley, when each linkages operated in differential lengths cables and differential displacements distances of hooks, displacing the linkages so as to the positions of the at least one or more units (for example 3-units) of solar energy radiation receivers assembly with another assemblies in desired directions to the sunrays. The main support beam connected either flexible cables or rigid spar-like pieces. so as to provide orientation in a second direction East-West in response to a second electric motorized pulley connected to spaced-apart in differential configuration of each at least one or more units (for example 3-units) of solar energy radiation receivers mounted on main support beams in differential angels relative to East-West movements, wherein connected with swivel coupler axis creates the sub-assembly modules 102 connected to step-aside main mast pillar. When at least one or more units (for example 3-units) solar energy radiation receivers, functions to receive solar energy from both sides; when one from the front side and the second from the back side, as received radiation energy from the albedo.

### DETAIL DESCRIPTION OF THE DRAWINGS

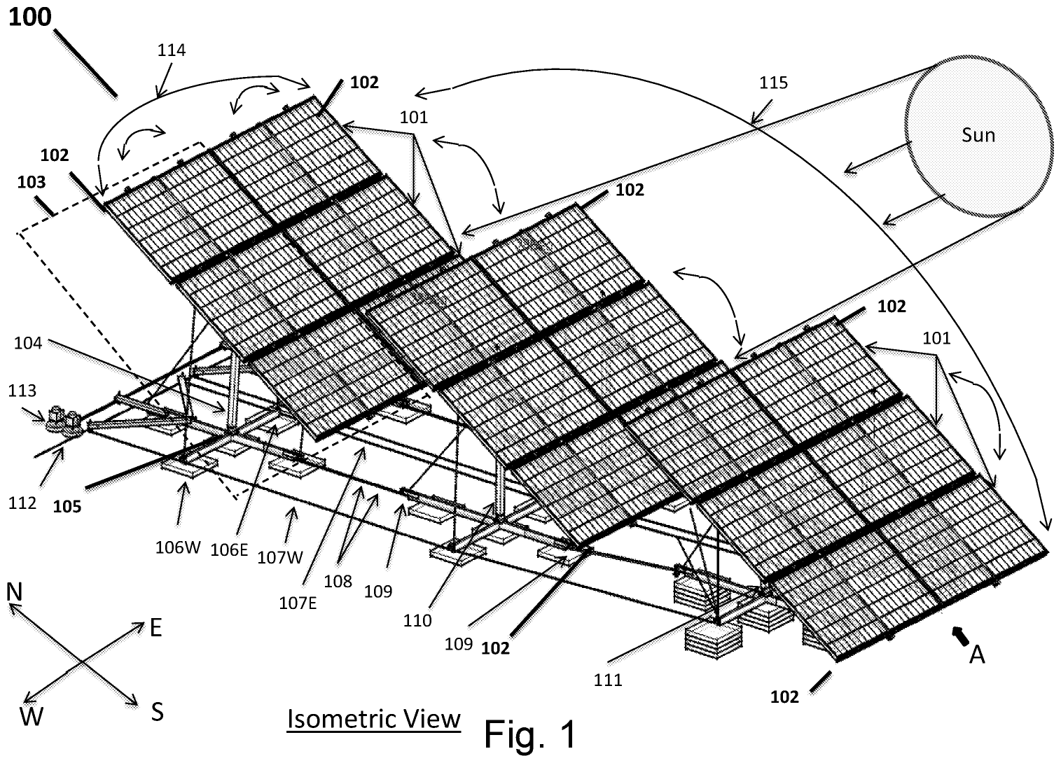

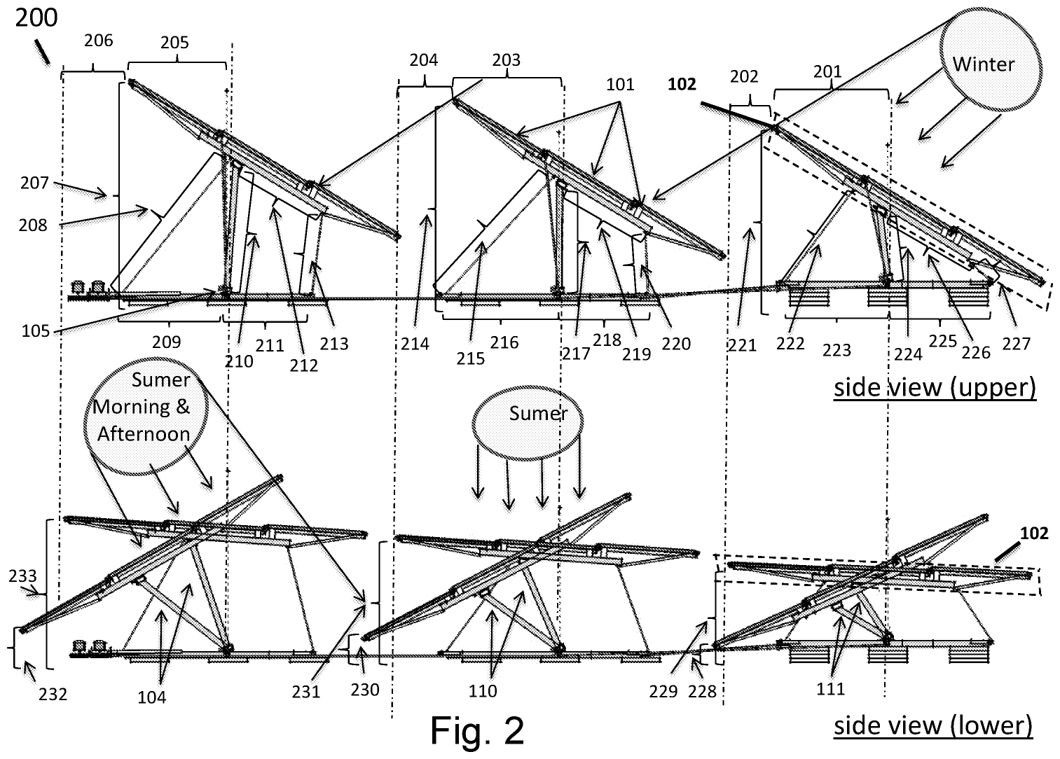

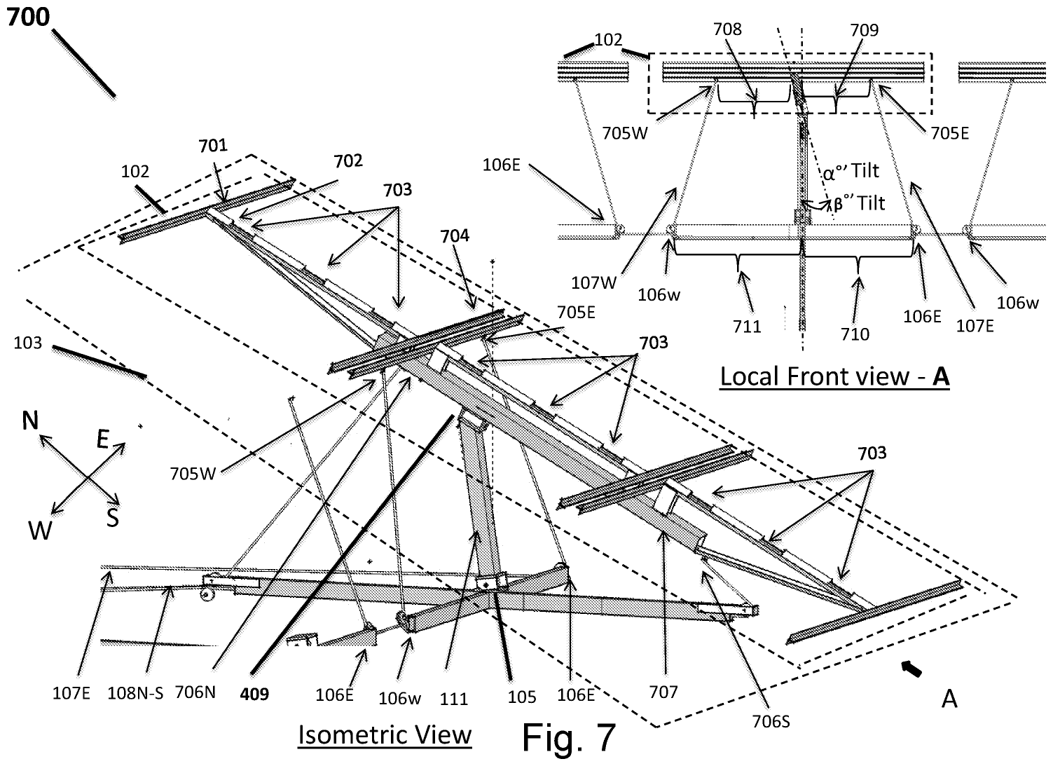

Referring now to the drawings and especially to FIG. 1, a combination of several single two-axis sun-trackers mechanism 103, configured the structure of differential telescopic elliptical arcs, consisting of multiple two-axis sun-trackers mechanisms facility 100 is comprising a plurality of multiple single two-axis sun-trackers mechanism 103 integrated with at least one or more units (for example 3-units) of solar energy radiation receivers as wheel as mirrors 101, which pivotally mounted on several rotatable differential lengths of step-aside main masts pillars supports 104, 110, 111, when a controlled pull and release cables in closed loops 108 N-S connected to two single or double rollers 109N and 109S, configured differential telescopic elevational and differential telescopic distances horizontal actuation of multiple 3-units of solar energy radiation receivers. when both sides of at least one or more units (for example 3-units of solar energy radiation receivers sub-assembly modules 102 function to receive solar energy from the front and back side from the albedo, the arrangement of FIG. 2, will provide the complete differential elevations and differential horizontal distances adjustments of FIG. 1, without requiring any additional mechanical attachments, since in each column there are at least one of 3-units of solar energy radiation receivers sub-assembly module 102 provides rotational displacement in azimuthal directions, when they are rotate along the risers and elliptical arcs of step-aside different lengths (for example, can be in ranges from 1-50-cm) mast pillars 104, 110, 111 relative to the surrounded other assemblies nearby. Similarly, cables in closed loops 107 E-W, connected to single or double roller 106E and 106W throw cables to rail support hooks (seen in FIG. 7) from there provides rotational displacement of at least one or more units (for example 3-units) of solar energy radiation receivers sub-assembly module 102 in azimuthal directions are rotate about riser and elliptical arc, at differential elevations and differential horizontal distances attachment hooks points 705E and 705W (See FIG. 7). controlled pull and release cables in closed loops 107 E-W, 108 N-S are supported by electric motor-driven pulleys, 112, 113 connected respectively, which have tension adjustment means, not shown in FIG. 1. Control closed loop 107 E-W, 108 N-S provides simultaneous azimuthal adjustment of at least one or more units (for example 3-units): of solar energy radiation receivers 101, such as electric motorized pulleys 112 and 113 are rotating the driven cables 107 E-W, 108 N-S. Similarly, those controlled pull and release cables in closed loops 107 E-W, 108 N-S supported throughout their lengths or changes in directional movements by a system of single or double rollers or the like. simultaneously provides rotational displacement of differential elevations and horizontal displacements distances of at least one or more units (for example 3-units of solar energy radiation receivers 101, such as motors pulleys 112, 113 rotatable drives cables 107 E-W, 108 N-S. When multiple two-axis sun-trackers mechanisms with nearby assemblies, change positions between the seasons and daily, it's configured the telescopic elliptical arcs 114 and simultaneously in the differential telescopic elliptical arc 115 of rows 115 and columns 114 movements, operated by the electric drivers systems for electric motors pulleys 112, 113 are of the type known in the art to provide precise rotational displacement in response to electrical signals applied to each motor. Thus, electric motorized pulleys 112 and 113 can be rotated by the precise amounts required to provide advancements 107 E-W, 108 N-S for each direction of adjustment, connected to upper main support beam structure (707) which continue through upper swivel coupler (409) connected to upper end main step-aside mast pillar in different lengths, for example, can be in ranges from 5-50c″m (104, 110, 111) and at a lower end to said base support junction structure (801), through a lower swivel coupler (105) at said lower end configured to allow said support beam structure (707) with the main step-aside mast pillar to pivot relative to said base in North-South direction and in relative parallel to that of the rows, and an upper swivel coupler (409) configured to allow said support beam structure (707) to pivot relative to said step-aside main mast pillar in an East-West direction and in relative parallel to that of the columns. Simultaneously, occur in differential elevations and differential horizontal elliptical arcs adjustments 114, 115 to the sun path, all above systems and movements; creates the smart multiple two-axis sun-trackers facility 100. although more or less control closed loops can be provided, according to the invention.

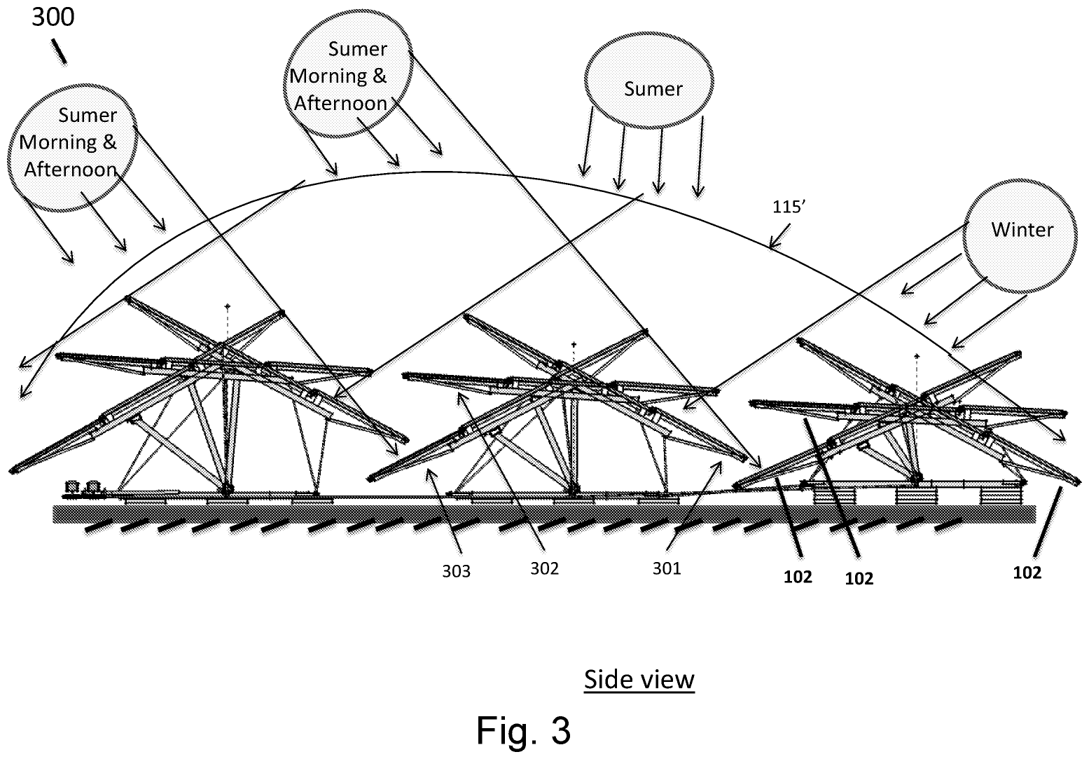

Reference is now made to FIG. 2 which schematically illustrates two side views which shows a comparison of two primary seasons of the year, designated by the numeral 200. In side view (upper), for example, during the winter it shows the sun's rays radiant on all surfaces of the first row (relative to sun) of 3-units of solar energy radiation receivers 101. At the same time, the sun radiate on the second row, but they fully cover only 2 solar energy radiation receivers 101 (see FIG. 1) out of the three solar radiation energy receivers, therefore, the lowest solar energy radiation receiver in the second row, is shaded from the top side of solar radiant energy receiver from the first row, and so it repeats itself in the rest of the rows, simultaneously the solar energy radiation receivers generate electricity from the albedo. For illustrative purpose, the mechanism of the rows was constructed respectively and spaced differentially from each other structure, so that during movement, all assemblies allows for creation of a new status, after about 3-4 months, this status will switching to the new status, so that the third lowest solar energy radiation receivers 101 (see FIG. 1) can come-out from the shaded free space between rows shows in the side view (lower), and switching to the status where during a major period of the year, all the solar energy radiation receivers 101 are fully exposed to radiant sun without any shadings effect, optimizing the entire footprint. All this can be seen in the differences between the different positions and distances in the North-South sun trackers movements, and the differences of free spaces between rows. As the seasons change, the arrangement shown in the two illustrations and presenting the differentials seasons of Winter, Sumer and daily sun path in the Summer morning & afternoon, can be reflected in differential distances of upper side view in Winter relatively to Sumer lower side view as seen in distances 201 and 202 relatively to distance 203 and 204, 205 and 206 respectively, all this comes out from the vertical and horizontal differential distances this is due to the fact that main mast pillar length is relatively different in each row, when the lower swivel coupler 105 (seen in FIG. 1) connected to the lower end of main mast pillars rotated clockwise and counter-clockwise, it reflected in the structure mechanism, as shown in displacement distance of main mast pillars 224, relatively it shorter than main mast pillars 217 and 210 supplemented with displacements distances 226, 219 and 212, as wheel as distance 227 relatively shorter than distance 220 and 213 respectively to distances 222, 215, 208 as wheel as distances 225, 218, 211 relatively and respectively to displacements distances 223, 216, 209, wherein said lower swivel coupler (105) in each sun-tracker mechanism structure in a same row (501) is connected to a same location in each base (223, 225; 216, 218; 209, 211) and wherein said lower swivel coupler (105) connection location to said base (801) is different in displacement relative to step-aside main mast pillar (for example 104, 110, 111 can be in ranges from 5-40c″m) and respectively to rollers 109N, 109S in each row (223, 225; 216, 218; 209, 211) for example, can be in ranges from 5-60c″m, more particularly and simultaneously can see in the differential telescopic heights between Winter and Sumer distances as 221, 214, 207 relatively to 229, 231, 233 and daily Summer morning and afternoon displacements distances 228, 230, 232. It can be seen with reference to FIG. 3.

An example of variant seasons reflected by different positions is shown in FIG. 3, designated by the numeral 300 comprising; sub-assembly module 102 (see FIG. 1) in Winter 301, sub-assembly module 102 in Summer 302, sub-assembly module 102 in the period of Summer morning& afternoon 303, those different sub-assemblies 102 which opens telescopically and elliptically as seen in the elliptical arc 115′ relatively to the suns locations. It combined the arrangement shown in FIG. 2, the same situations occur when the whole system turns back and forth when the North-South single-axis sun-tracker is reversed.

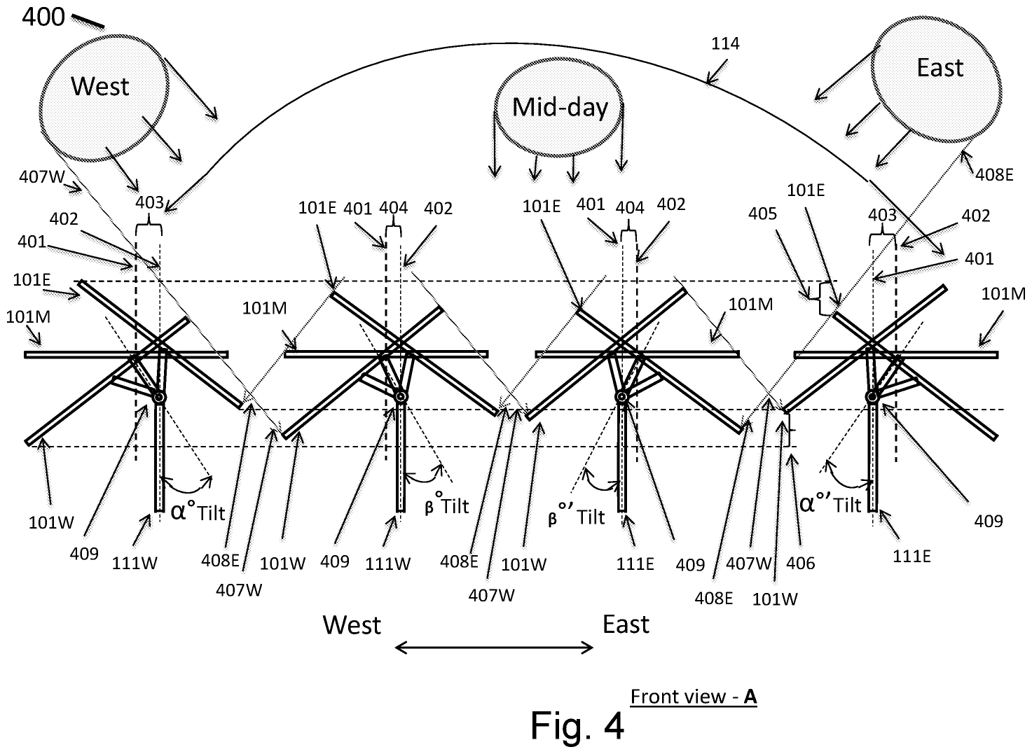

When all movements of FIG. 3 integrated with movements of FIG. 4, it reflects the directions toward to North-East, North-West and South East, South-West positions.

Referring now to FIG. 4, another front view A of East-West columns mechanism according to the invention, designated by the numeral 400, is showing at least two assembly mechanisms (this example show 4 assemblies) consisting of step-aside upper swivel coupler 409 mounted with the step-aside main mast pillar 111; East step-aside (off-center), when in the opposite side, mounted step-aside (off-center) upper swivel coupler 409 with the step-aside main mast pillar 111 West, when the different distance relative to sub-assembly modules support structure (102) for example, can be in ranges from 5-60c″m.

To provide the daily arrangement shown by comparing between East, Mid-day and West day, which it reflected by two majors sides East morning and similar opposite side West afternoon positions by front view A, as vertical center dotted-line 401 of the solar energy radiation receivers 101E/102E connected to step-aside swivel coupler 409 reflected by step-aside dotted-line 402 step-aside mast pillar 111E in angle α°′ tilted seen by different distance relative to sub-assembly modules support structure (102) or at least one or multiple solar radiation receivers (101) for example, can be in ranges from 5-60c″m distance 403, the same configuration seen as center dotted-line 401 of the solar energy radiation receivers 101E/102E with its fully open space for the sunray 408E, connected to step-aside swivel coupler 409 with step-aside dotted-line 402 step-aside main mast pillar 111E in angle β°′ tilted seen by angular displacement is different relative to sub-assembly modules support structure (102) or (101) for example, can be in ranges from 5-60c″m distance 404, when in the Mid-day all solar energy radiation receivers 101M positioned horizontally with the faces to the Mid-day Sunrays. in the afternoon all solar energy radiation receivers 101 rotated in swivel coupler 409 to West afternoon with the same configuration shown in the variant East morning side positions, the same configuration appear in the opposite side mounted vertical center dotted-line 401 of the solar energy radiation receivers 101W connected to step-aside swivel coupler 409 reflected by step-aside dotted-line 402 of step-aside main mast pillar 111W in angle α° tilted seen by distance 403, the same configuration seen as center dotted-line 401 of the solar energy radiation receivers 101W with its fully open space for the sunray 407W, connected to step-aside swivel coupler 409 with step-aside dotted-line 402 of step-aside main mast pillar 111W in angle β° tilted seen by distance 404, as well as center dotted-line 401 of the solar energy radiation receivers 101W with its fully open space for the sunray 407W, connected to step-aside swivel coupler 409 with step-aside dotted-line 402 of step-aside main mast pillar 111W in angle α° tilted seen by distance 403. More particular wherein center longitudinal axis line (401) of sub-assembly modules support structure (102) is eccentric for example, can be in ranges from 5-30c″m relative to main mast pillar (111) and offset respectively (710, 711) relatively to base support structure (801). However the distance 405 reflects the gaps between the columns and the same distance 406 occur in the West side.

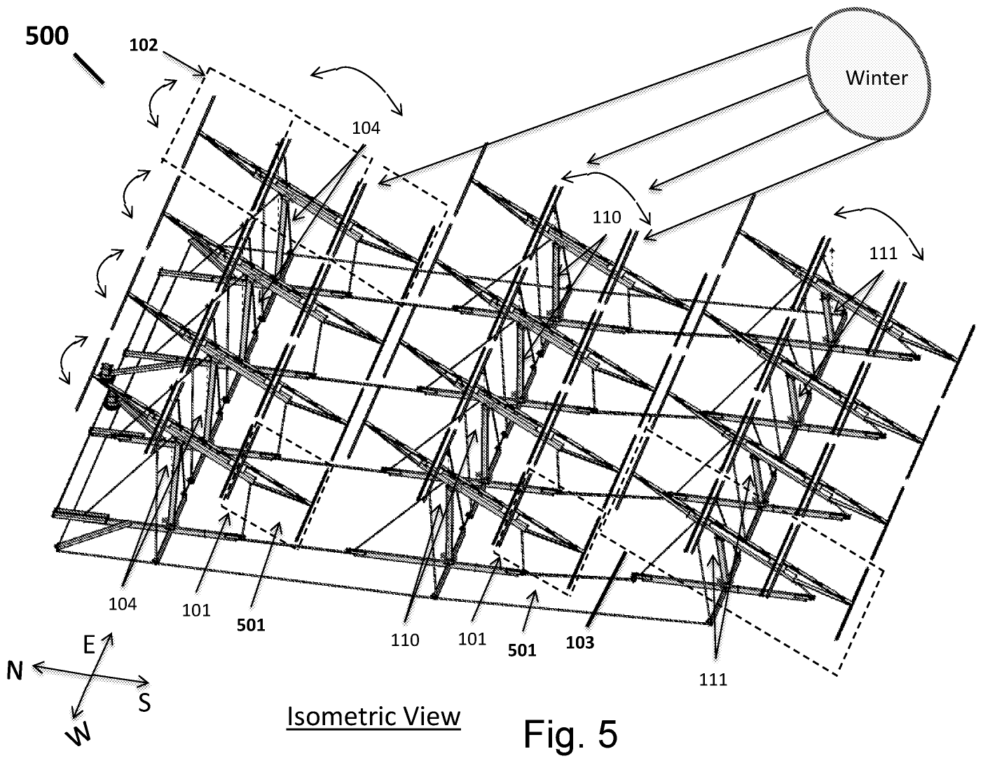

Reference is made to FIG. 5 shows isometric view designated by the numeral 500 which schematically illustrates an example of a cluster of at least two or more of 4 columns and 3 rows in Winter and Mid-day positions with faces to sun direction. Moreover, seen additional quantities of single or double step-aside layers of hybrid dual faced PV thermal panels or any solar energy radiation receivers 101, installed in the free space between rows 501.

Mechanically sees the doted lines sub-assembly modules 102 (without 3-units of solar energy radiation receivers as wheel as mirrors 101), connected to step-aside main mast pillar 111, 110 and 104 all identical on the same row emphasized by a doted lines of multiple two-axis sun-tracker mechanism 103 (see FIG. 1).

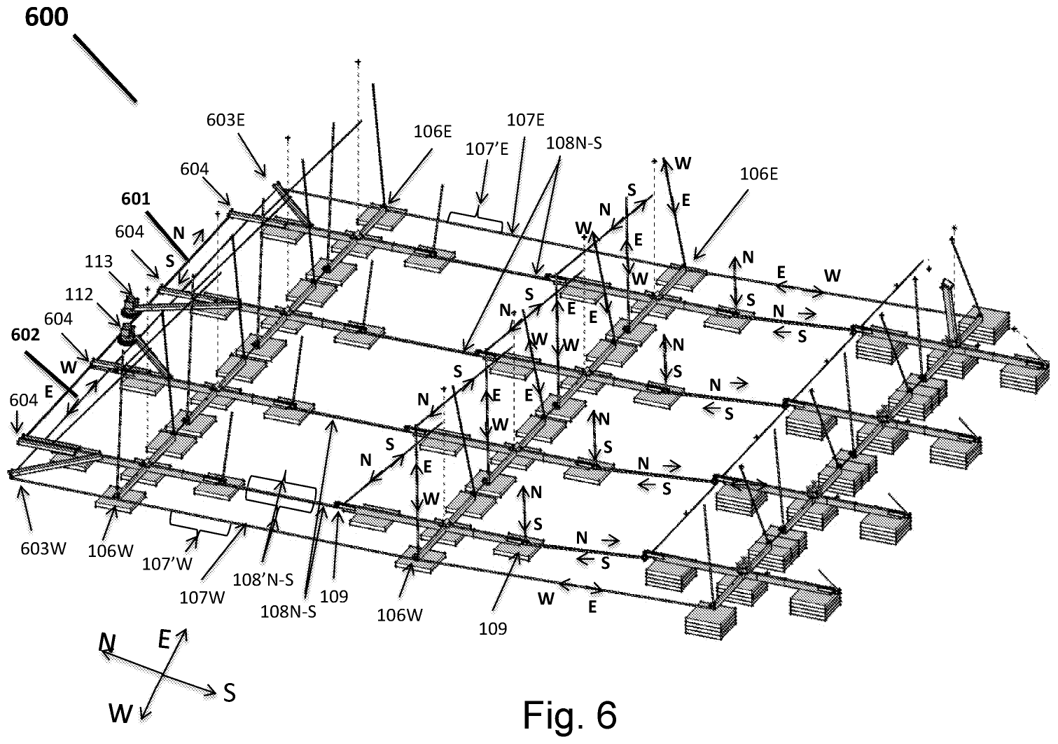

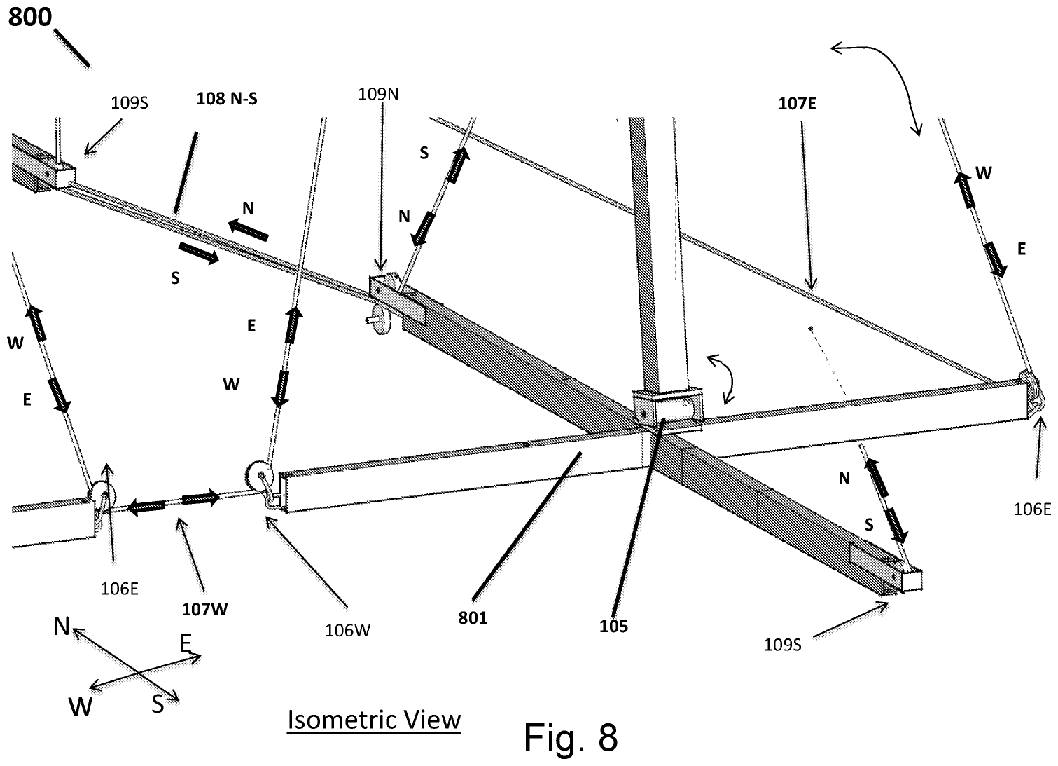

FIG. 6 Another mechanisms of controlled pull and release cables in closed loops designated by the numeral 600, for example comprises 4-columns of North-South cables in closed loops 601 attached to cable 108N-S of the same main equal displacement cables length loops 108′N-S in an opposing direction (see FIG. 1) by cables clamps, followed by a double pulley shaft 604 driven clockwise and counterclockwise in the same desired amount of movement (distance) by an electrical motor with a double pulley or alternatively an electrical elongated shaft 113 connected to said controlled pull and release cables in closed loops, mounted in basis structure support junction (801 see FIG. 8.), this would therefore have at least two or more units, for example 4-columns engaged with 3-rows East-West controlled pull and release cables in closed loops controlled pull and release cables in closed loops 602 attached to cable 107W and 107E with the same main equal displacement cables length loops 107′E and 107W in an opposing direction (See FIG. 1) by cables clamps, following with shaft pulley 603E and 603W driven clockwise and counterclockwise within the same desired amount movements (distance) by an electric motor with single pulley or alternatively electrical elongated shaft 112, mounted in basis structure support junction (see FIG. 8).

Wherein throughout multiple two-axis sun-tracker mechanism 103 (see FIG. 1), a major central cable passes, operated as manifold and separately connected with sub-cables loops to each separate two-axis sun-tracker mechanism 103 at spaced-apart portions.

FIG. 7 shows an isometric view designated by the numeral 700 (reflecting the single two-axis sun-tracker mechanism 103 See FIG. 1), comprising upper support rail 701 and lower support rail 704, connected to middle central sub-support beam 702 with evacuated sections 703 configure the shape of H, simultaneously used to reflect light (Albedo) to the back side of the dual faces PV thermal panels. interconnected by hooks means 705E and 705W to cables 107 East-West throw are mounted above upper main support beam 707 with the swivel coupler 409 (see FIG. 4), creates the sub-assembly module 102 (see FIG. 1), a sub-assembly module (102) mounted above upper main support beam structure 707 rotated North-South in elliptical arc manner interconnected by hooks means 706N and 706S to two cables 108 North-South, when connected with lower swivel coupler axis 105 to step-aside main mast pillar 111 (see FIG. 1), configure the two-axis sun tracker elliptical arc mechanism 103 (see FIG. 1), when plurality of multiple two-axis elliptical arcs mechanism 103 interconnected with multiple controlled pull and release cables in closed loops 107E-W, 108N-S (see FIG. 1) to two motorized electric motor pulley, controlled and powered by heliostat system, creating the solar differential telescopic elliptical arcs, consist of multiple mechanisms of two-axis sun trackers mechanisms facilities 100 (see FIG. 1).

Local Front view-A shows the at least one or more units (for example 3-units) of solar energy radiation receivers of sub-assembly module 102, connected to the main mast pillar step aside distances 710 and 711 relative to displacements distances 708 and 709 tilted aside in angle α°′ and angle β°′ respectively.

FIG. 8 shows an isometric view designated by the numeral 800 shows the basis structure of support junction 801 for central step-aside mast pillar, attached to cable in closed loops 107E through to the roller 106E, continue through the sub-assembly module 102 (see in FIG. 7) to roller 106W and continue to cable 107W by cables clamps, from there continue to roller 106E. controlled pull and release cables in closed loops 108N-S attached to the roller 109N continue throw the upper main support beam 707 (see FIG. 7) from there to roller 109S and continue back to cable 108N-S by cables clamps, from there continue to roller 109S. Moreover shows the lower swivel coupler axis 105 (see FIG. 1) connected to step-aside main mast pillar.

The structure of differential telescopic elliptical arcs, consisting of multiple mechanisms of two-axis sun-trackers facilities 100 (see FIG. 1) for solar energy radiation receivers 101 described above find particular application as heliostats, devices which track the sun throughout the daylight hours, steadily directing solar radiant energy to solar energy radiation receivers 101. The solar structure of differential telescopic elliptical arcs, consisting of multiple two-axis sun-trackers mechanisms facilities 100 (see FIG. 1) systems according to the invention, is particularly advantageous since it can simultaneously align a plurality of individual solar energy radiation receivers 101, which will enable the direction of the solar radiation energy to those solar energy radiation receivers targets. Either type of solar energy radiation receivers has the ability to converts the radiation energy into a different form, such as electrical and hot water energy.

It will become apparent to those skilled in the art that the controlled pull and release cables in closed loops shown and described above could be replaced by rigid-spar like members to provide the linkage means coupling each solar energy radiation receiver to a drive source. Also, while the attachment of linkage mechanisms to solar energy radiation receivers has been shown at solar energy radiation receivers supports positions, other arrangements are possible. For example, the linkage mechanisms could pass through apertures formed in interior portions of solar energy radiation receiver's supports.

The foregoing is considered as illustrative explanation of the principles of the invention. Further, since numerous modifications and changes will readily occur to those skilled in the art, it is not desired to limit the invention to the exact construction and operations shown and described above, and accordingly all suitable modifications and equivalents may be resorted to, all within the scope of the invention.

1. A system of sun-trackers structures arranged in an array of rows and columns, comprising:
in each two-axis sun-tracker mechanism structure (103);
a sub-assembly modules support structure (102) to support at least one or multiple solar radiation receivers (101);
a support rails (701) and (704) connected to middle central sub-support beam (702) with evacuated sections (703);
a step-aside main mast pillar (for example 104, 110, 111);
a controlled pull and release cables in closed loops (108N, 108S) and controlled pull and release cables in closed loops (107E, 107W)
a base (801) to provide ground support; and
a step-aside main mast pillar (104, 110, 111) connected at an upper end to said sub-assembly modules support structure (102) and at a lower end to said base ground support (801), and through a lower swivel coupler (105) at said lower end configured to allow said sub-assembly modules support structure (102) with the main step-aside mast pillar to pivot relative to said base in North-South direction and in relative parallel to that of the rows attached to controlled pull and release cables in closed loops (108N, 108S), and an upper swivel coupler (409) configured to allow said sub-assembly modules support structure (102) to pivot relative to said step-aside main mast pillar and to the base in an East-West direction and in relative parallel to that of the columns attached to controlled pull and release cables in closed loops (107E, 107W), and
wherein said lower swivel coupler (105) in each sun-tracker mechanism structure (103) in a same row (501) is connected to a same location in each base (223, 225; 216, 218; 209, 211) and wherein said lower swivel coupler (105) connection location to said base (801) is different in displacements distances relative to step-aside main mast pillar (for example 104, 110, 111 can be in ranges from 5-40c″m) and respectively to rollers 109N, 109S in each row (223, 225; 216, 218; 209, 211) for example, can be in ranges from 5-60c″m, and simultaneously, wherein said lower swivel coupler (105) to pivot relative to said base (801) in each row, wherein displacements distances in heights is different relative to each row (501) in displacements distances of 221, 214, 207 relatively to 229, 231, 233 and 228, 230, 232 (for example, can be in ranges from 5-50c″m), and
wherein said upper swivel coupler (409) in each sun-track mechanism structure (103) in a same row (501) is connected to a same location in each sub-assembly modules support structure (226; 219; 212), and wherein said upper coupler (409) connection to said sub-assembly modules support structure (102) is different in displacement relative to sub-assembly modules support structure (102) or (101) and respectively to rollers 106E and 106W in each row (226; 219; 212) for example, can be in ranges from 5-50c″m.

2. The system according to claim 1 wherein said step-aside main mast pillars (for example 104, 110, 111) in each sun tracker mechanism structure (103) in a same row (501) is of a same length (224; 217; 210), and wherein said step-aside main mast pillar length for example, can be in ranges from 5-50c″m is relatively different in between each row (224; 217; 210).

3. The system according to claim 1 wherein said sub-assembly modules support structure (102) comprises at least one or more upper and lower support rail 701 and 704 connected to middle central sub-support beam 702 with evacuated sections 703 configure the shape of H to support said multiple solar radiation receivers (101), simultaneously used to reflect light (albedo) to the back side of the dual faces PV thermal panels, and main support beam (707) angularly displaced (α, β, α′, β′) relative to a longitudinal axis (401) of said step-aside main mast pillar (for example 111), and wherein said angular displacement in each sun tracker structure (103) in a same column is the same, and wherein said angular displacement is different relative to sub-assembly modules support structure (102) in each column (α, β, α′, β′).

4. The system according to claim 3 wherein one of said upper support rails (701) comprises hooks means (705E, 705W) to attach cables (107E, 107W) associated with a drive system (112), to allow pivoting said sub-assembly modules support structure (102) in a direction relative parallel to that of the columns.

5. The system according to claim 4 wherein a location of said hooks means (705E, 705W) on said one of said upper-support rails (701) is the same for all sun-tracker structures (103) in a same column, and said hooks means location (708, 709) is different relative to sub-assembly modules support structure (102) in each column.

6. The system according to claim 3 wherein said main support beam (707) comprises hooks means (706N, 706S) to attach cables (108N, 108S) associated with a drive system (113), to allow pivoting said sub-assembly modules support structure (102) in a direction relatively parallel to that of the rows (501).

7. The system according to claim 1 further comprising a drive system (600), said system comprising a first groups of cables (108N, 108S) configured to simultaneously impart a pivotal motion in a direction parallel to the rows (501) to each main mast pillar (111) in each two-axis sun-tracker mechanism structure (103), and a second groups of cables (107E, 107W) configured to simultaneously impart a pivotal motion in a direction parallel to the columns to each sub-assembly modules support structure (102) in each two-axis sun-tracker mechanism structure (103).

8. The system according to claim 7 wherein said first groups of cables (108N, 108S) is arranged in a closed loop configuration along each column, and said second groups of cables (107E, 107W) is arranged in a closed loop configuration along each row (501).

9. The system according to claim 8 wherein a displacement distance of cable (108N) between each two-axis sun-tracker mechanism structure (103) in each column is the same and is countered by a equal in one length displacement of cable (108S) in an opposing direction.

10. The system according to claim 8 wherein a displacement of cables (107W) between each two-axis sun tracker mechanism structure (103) in each row (501) is countered by a equal in one length displacement of cables (107E) in an opposing direction.

11. The system according to claim 7 wherein said drive system (600) comprises a single motor or alternatively electrical elongated shaft (113) to drive said groups of cables (108N, 108S) and single motor or alternatively electrical elongated shaft (112) to drive said second groups of cables (107E, 107W).

12. The system according to claim 1 wherein said plurality of solar radiation receivers (101) comprises hybrid dual faced PV thermal panels.

13. The system according to claim 6 wherein a location of said hooks means (226; 219; 212) on said upper main support beam (707) is the same for all sun-tracking structures (103) in a same row (501), and said hooks means location (226; 219; 212) is different in each row.

14. The system according to claim 1 wherein said center longitudinal axis line (401) of sub-assembly modules support structure (102) is eccentric for example, can be in ranges from 5-30c″m relative to main central mast pillar (111) and offset respectively (710, 711) relatively to base support structure (801).
